(19) United States
(12) Patent Application Publication
(10) Pub. No.: US 2013/0033126 A1
(43) Pub. Date: Feb. 7, 2013

(54) LINEAR VIBRATION DEVICE

(71) Applicant: Joon CHOI, Gyunggi-do (KR)

(72) Inventor: Joon CHOI, Gyunggi-do (KR)

(73) Assignee: SAMSUNG ELECTRO-MECHANICS CO., LTD., Gyunggi-do (KR)

(21) Appl. No.: 13/282,796

(22) Filed: Oct. 27, 2011

(30) Foreign Application Priority Data
Aug. 5, 2011 (KR) 10-2011-0078165

(51) Int. Cl. H02K 33/00

(52) U.S. Cl. 310/25

(57) ABSTRACT

Disclosed herein is a linear vibration device including: a stator that includes magnets, a bracket, and a case having an inner space formed therein and coupled to the bracket; and a vibrator that includes a coil facing the magnets, a weight body coupled to the coil, a flexible printed circuit (FPC) coupled to a lower portion of the weight body, and an elastic member having one end coupled to the case and the other end coupled to the coil and is received in the case, wherein the magnets are disposed at a lower portion of the coil of the vibrator and include a first magnet having a magnetic fluid applied to a lower portion thereof and a second magnet facing the first magnet and coupled to an upper side of the case.

### CROSS REFERENCE TO RELATED APPLICATION

This application claims the benefit of Korean Patent Application No. 10-2011-0078165, filed on Aug. 5, 2011, entitled “Linear Vibration Device”, which is hereby incorporated by reference in its entirety into this application.

### BACKGROUND OF THE INVENTION

1. Technical Field

The present invention relates to a linear vibration device.

2. Description of the Related Art

A general linear vibration device, which is a component converting an electrical energy into mechanical vibration using a principle of generating electromagnetic force, is mounted in a mobile communication terminal, a portable terminal, and the like, to be used for silently notifying a user of call reception.

Further, in a situation in which small-sized and high quality components are required in a mobile communication terminal in accordance with the trend in which a multi-functional mobile communication terminal has been prominent due to the rapid expansion in wireless communication and mobile phone markets, performance and a technology of a linear vibration device has also been developed daily in order to overcome a disadvantage of an existing product and significantly improve quality.

In addition, as the release of a cellular phone having a large-sized liquid crystal display (LCD) screen has rapidly increased in recent years, a touch screen scheme has been used. As a result, the linear vibration device has been used to generate vibration at the time of touch, such that the demand thereof has increased.

Meanwhile, performance particularly required in the vibration according to the touch of the touch screen is as follows. First, as the number of vibration generations according to the touch becomes larger than that of vibration generations at the time of call reception, an operation lifespan time needs to increase. Second, in order to allow users to feel the vibration at the time of touch, a response speed of the vibration needs to increase in accordance with a touch speed of the screen.

A linear vibration device capable of satisfying the above-mentioned characteristics has a resonant frequency determined by a spring and a vibrator part connected to the spring and is excited by electromagnetic force to thereby generate vibration. In addition, the electromagnetic force is generated by the interaction between a magnet of the vibrator part and a current applied to a coil of a stator part and having a predetermined frequency.

In the case of the linear vibration device configured as described above, as the vibrator part moves vertically, it collides with a case or a bracket to thereby cause touch noise. In order to prevent the above-mentioned problem, a ring shaped band has been formed by applying MF or a damping material (rubber, Poron, or the like) has been used.

However, when the MF is used, the MF is made of liquid to be scattered to the surrounding area at the time of excessive impact, such that it is separated from its position. Therefore, a damping function is weakened, such that noise is generated at the time of a vibration operation. In addition, the damping material such as rubber, Poron, or the like, occupies a predetermined volume, such that it may not be easily disposed in a limited space and a degree of freedom in design is deteriorated.

### SUMMARY OF THE INVENTION

The present invention has been made in an effort to provide a linear vibration device capable of reducing a driving sound due to friction between components and improving reliability.

According to a preferred embodiment of the present invention, there is provided a linear vibration device including: a stator that includes magnets, a bracket, and a case having an inner space formed therein and coupled to the bracket; and a vibrator that includes a coil facing the magnets, a weight body coupled to the coil, a flexible printed circuit (FPC) coupled to a lower portion of the weight body, and an elastic member having one end coupled to the case and the other end coupled to the coil and is received in the case, wherein the magnets are disposed at a lower portion of the coil of the vibrator and include a first magnet having a magnetic fluid applied to a lower portion thereof and a second magnet facing the first magnet and coupled to an upper side of the case.

The second magnet may include a plate mounted at a lower portion thereof.

Facing surfaces of the first and second magnets may have the same polarity.

The vibrator may further include a yoke coupled to the lower portion of the weight body.

The weight body may include a hollow part formed therein, wherein the hollow part receives a cylindrical yoke and the coil.

The elastic member and the coil may include a hollow part formed therein so as to be linearly movable in a state in which the stator is contained therein.

### BRIEF DESCRIPTION OF THE DRAWINGS

FIG. 1 is a cross-sectional view of the entire linear vibration device 100 according to a first preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

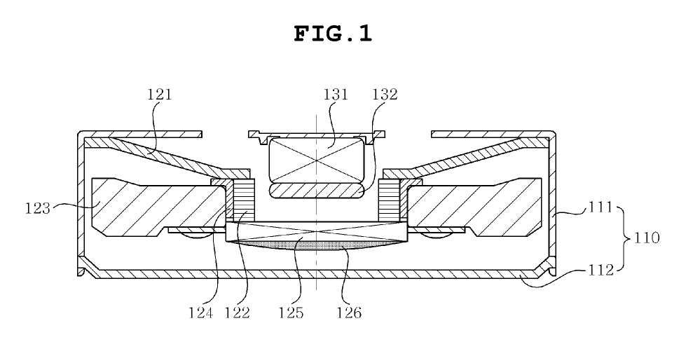

FIG. 1 is a cross-sectional view of the entire linear vibration device 100 according to a first preferred embodiment of the present invention.

As shown in FIG. 1, a linear vibration device 100 according to a preferred embodiment of the present invention includes a stator 110 that includes a case 111 and a bracket 112 and a vibrator 120 that includes an elastic member 121, a coil 122, a weight body 123, a yoke 124, a first magnet 125, and a magnetic fluid 126, wherein the case 111 includes a second magnet 131 mounted at a lower portion thereof and the second magnet 131 includes a plate 132 mounted at a lower portion thereof.

The case 111, which forms an inner space of the linear vibration device 100, protects components embedded therein from the outside. The case 111 may be made of an iron-based material, and the elastic member 121 is fixed to an upper edge portion of the case 111.

The bracket 112 is disposed at an upper portion of the case 111 and protects a product from the outside together with the case 111.

The case 111 and the bracket 112 configure the stator 110 of the linear vibration device 100.

The elastic member 121 is fixed to the upper edge portion of the case 111 to thereby support vertical vibration of the vibrator 120. As the elastic member 121, a leaf spring is generally used.

The coil 122 is mounted at a central lower portion of the elastic member 121 and generates vibration force by electromagnetic force with the magnet which it faces while being vertically vibrated.

The weight body 123 is mounted at the yoke 124 and is vertically vibrated, and weight of the weight body 123 is associated with the vibration force.

The yoke 124 is mounted between the coil 122 and the weight body 123 and supports the weight body 123 to thereby support the vertical vibration of the weight body 123.

The first magnet 125 is mounted at a lower portion of the coil 122 and a side of the weight body 123, such that it vibrates together with the vibrator 120 at the time of vibration of the vibrator 120.

The first magnet 125 includes the magnetic fluid 126 applied to a lower portion thereof.

The magnetic flux 126, which is liquid having magnetism, is applied to the lower portion of the first magnet 125, thereby making it possible prevent friction or abrasion from being generated due to the collision between the vibrator 120 and the bracket 112 at the time of driving of the vibrator 120.

The case 111 includes the second magnet 131 mounted at the upper side thereof and the second magnet 131 includes the plate 132 mounted at a lower portion thereof.

When the vibrator 120 is driven, the first magnet 125 mounted in the vibrator 120 and the second magnet 131 mounted the case 111 do not touch each other due to repulsive force of polarities therebetween.

In addition, the first magnet 125 includes the magnetic fluid 126 applied to the lower portion thereof, thereby making it possible to prevent friction between the first magnet 125 and the bracket 112.

Facing surfaces of the first and second magnets 125 and 131 may have the same polarity in order to increase magnetic efficiency.

That is, the linear vibration device 100 according to the preferred embodiment of the present invention includes the stator 110 that includes the magnets 125 and 131, the bracket 112, and the case 111 having the inner space formed therein and coupled to the bracket 112; and the vibrator 120 that includes the coil 122 facing the magnets 125 and 131, the weight body 123 coupled to the coil 122, a flexible printed circuit (FPC) (not shown) coupled to the lower portion of the weight body 123, and the elastic member 121 having one end coupled to the case 111 and the other end coupled to the coil 122 and is received in the case 111.

Here, the magnets 125 and 131 are disposed at the lower portion of the coil 122 of the vibrator 120 and include the first magnet 125 having the magnetic fluid 126 applied to the lower portion thereof and the second magnet 131 facing the first magnet 125 and coupled to the upper side of the case 111.

In addition, the second magnet 131 includes the plate mounted at the lower portion thereof.

As set forth above, with the linear vibration device 100 according to the preferred embodiment of the present invention having the above-mentioned structure, the second magnet 131 is mounted in the stator 110, the first magnet 125 is mounted in the vibrator 120, and the first and second magnets 125 and 131 are disposed to have repulsive force therebetween, thereby making it possible to prevent friction and abrasion between the stator 110 and the vibrator 120 without forming a separate damper.

In addition, the first magnet 125 includes the magnetic fluid 126 applied to the lower portion thereof, thereby making it possible to prevent friction and abrasion between the first magnet 125 and the bracket 112.

Although the preferred embodiments of the present invention have been disclosed for illustrative purposes, they are for specifically explaining the present invention and thus a linear vibration device according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A linear vibration device comprising:
a stator that includes magnets, a bracket, and a case having an inner space formed therein and coupled to the bracket; and
a vibrator that includes a coil facing the magnets, a weight body coupled to the coil, a flexible printed circuit (FPC) coupled to a lower portion of the weight body, and an elastic member having one end coupled to the case and the other end coupled to the coil and is received in the case,
wherein the magnets are disposed at a lower portion of the coil of the vibrator and include a first magnet having a magnetic fluid applied to a lower portion thereof and a second magnet facing the first magnet and coupled to an upper side of the case.

2. The linear vibration device as set forth in claim 1, wherein the second magnet includes a plate mounted at a lower portion thereof.

3. The linear vibration device as set forth in claim 1, wherein facing surfaces of the first and second magnets have the same polarity.

4. The linear vibration device as set forth in claim 1, wherein the vibrator further includes a yoke coupled to the lower portion of the weight body.

5. The linear vibration device as set forth in claim 1, wherein the weight body includes a hollow part formed therein, the hollow part receiving a cylindrical yoke and the coil.

6. The linear vibration device as set forth in claim 1, wherein the elastic member and the coil include a hollow part formed therein so as to be linearly movable in a state in which the stator is contained therein.
